(19) United States
(12) Patent Application Publication
(10) Pub. No.: US 2011/0197510 A1
(43) Pub. Date: Aug. 18, 2011

(54) METHOD AND APPARATUS TO REACTIVATE CARBON SOLIDS

(76) Inventors: Boris Nickolaevich Eiteneer, Irvine, CA (US); Judeth Helen Brannon Corry, Manvel, TX (US)

(21) Appl. No.: 12/706,156

(22) Filed: Feb. 16, 2010

(51) Int. Cl. C10B 1/00; C10J 3/46; F27B 15/08

(52) U.S. Cl. 48/89; 48/197 R; 422/145

(57) ABSTRACT

A method of operating a gasification facility includes injecting a carbonaceous material into a gasification reactor. The method also includes converting at least a portion of the carbonaceous material into a solid waste byproduct that includes residual carbon. The method further includes reactivating at least a portion of the residual carbon. The method also includes injecting at least a portion of the reactivated carbon into the gasification reactor.

### BACKGROUND OF THE INVENTION

The present invention herein relates generally to carbon reactivation systems, and more particularly, to methods and apparatus for reactivating carbon solids to facilitate operation of synthetic gas production facilities.

At least some known gasification plants include a gasification system that is integrated with at least one power-producing turbine system, to form an integrated gasification combined cycle (IGCC) power generation plant. Some of such known gasification systems convert a mixture of fuel, air or oxygen, steam, and/or CO₂ into a synthetic gas, or “syngas”. Many of such systems include a gasification reactor that generates syngas therein, that is channeled to a gas turbine engine combustor, for use in powering a generator that supplies electrical power to a power grid. Exhaust from at least some known gas turbine engines is supplied to a heat recovery steam generator (HRSG) that generates steam for use in driving a steam turbine. The steam turbine also drives an electrical generator that provides electrical power to the power grid.

In at least some of the known gasification systems, during the syngas conversion process, solid waste materials that may be channeled from the gasification reactor are either reinjected back into the reactor or are permanently channeled from the reactor and offered for sale to third-parties as industrial byproducts. Under certain conditions, at least some of such solids include substantial amounts of residual carbon. However, if the amount of residual carbon content within the solids exceeds a predetermined threshold value, such solids are deemed “high-carbon” are not sold as byproducts but rather may be disposed of at cost to the owner.

In some instances, because the amount of residual carbon within such high-carbon solids includes additional potential heat energy, the high-carbon solids are recycled back to the gasification reactor for use in the syngas conversion process. However, a gasification reactivity of the residual carbon is likely to be lower than the reactivity of carbon typically included within a fresh fuel feed source, i.e., fuel that has not previously been injected into the gasification reactor. As such, fresh fuel must be mixed with the high carbon solids prior to the mixture being injected into the gasification reactor. As a result, an efficiency of syngas production may be reduced.

### BRIEF DESCRIPTION OF THE INVENTION

In one aspect, a method of operating a gasification facility is provided. The method includes injecting a carbonaceous material into a gasification reactor. The method also includes converting at least a portion of the carbonaceous material into a solid waste byproduct that includes residual carbon. The method further includes reactivating at least a portion of the residual carbon. The method also includes injecting at least a portion of the reactivated carbon into the gasification reactor.

In another aspect, a carbon reactivation system is provided. The carbon reactivation system includes at least one of a solid waste byproducts conduit coupled in flow communication with a solid waste generation system and a reactivated solids conduit coupled in flow communication with a solid waste consumption system. The carbon reactivation system also includes a carbon reactivation apparatus coupled in flow communication with at least one of the solid waste byproducts conduit and the reactivated solids conduit.

In yet another aspect, a gasification system is provided. The gasification system includes a gasification reactor that produces solid waste byproducts. The gasification system also includes a solid waste byproduct collection apparatus coupled in flow communication with the gasification reactor. The gasification system further includes a carbon reactivation system. The carbon reactivation system includes at least one solid waste byproducts conduit coupled in flow communication with the solid waste byproduct collection apparatus. The carbon reactivation system also includes a carbon reactivation apparatus coupled in flow communication with the at least one solid waste byproducts conduit.

### BRIEF DESCRIPTION OF THE DRAWINGS

The embodiments described herein may be better understood by referring to the following description in conjunction with the accompanying drawings.

FIG. 1 is a schematic diagram of an exemplary integrated gasification combined-cycle (IGCC) power generation plant including an exemplary carbon reactivation system used with the IGCC power generation plant; and

FIG. 2 is a flow chart illustrating an exemplary method of operating the IGCC power generation plant shown in FIG. 1.

### DETAILED DESCRIPTION OF THE INVENTION

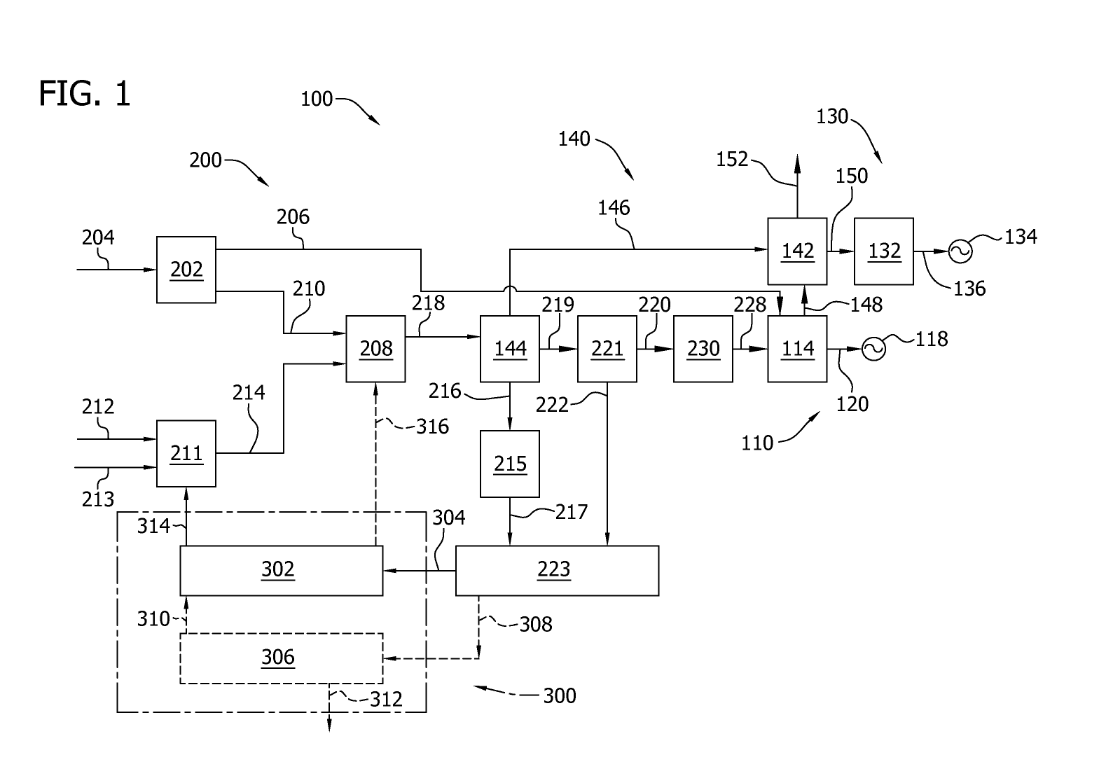

FIG. 1 is a schematic diagram of an exemplary gasification facility, specifically, an exemplary integrated gasification combined-cycle (IGCC) power generation plant 100. Alternatively, the method and apparatus to produce synthetic gas as described herein may be used with any gasification facility in any suitable configuration that that enables such method and apparatus to function as described herein. In the exemplary embodiment, IGCC plant 100 includes a gas turbine engine 110. A turbine 114 is rotatably coupled to a first electrical generator 118 via a first rotor 120. Turbine 114 is coupled in flow communication with at least one fuel source and at least one oxidizer source, including, but not limited to, air (both sources described in more detail below) and receives fuel and oxidizer from the fuel source and the oxidizer source (neither shown in FIG. 1), respectively. Turbine 114 mixes the oxidizer and fuel, produces hot combustion gases (not shown), and converts the heat energy within the gases to rotational energy. The rotational energy is transmitted to generator 118 via rotor 120, wherein generator 118 converts the rotational energy to electrical energy (not shown) for transmission to at least one load, including, but not limited to, an electrical power grid (not shown).

In the exemplary embodiment, IGCC plant 100 also includes a steam turbine engine 130. More specifically, in the exemplary embodiment, engine 130 includes a steam turbine 132 that is coupled to a second electrical generator 134 via a second rotor 136.

IGCC plant 100 also includes a steam generation system 140. In the exemplary embodiment, system 140 includes at least one heat recovery steam generator (HRSG) 142 that receives exhaust gases (not shown) from turbine 114 via an exhaust gas conduit 148 that enables heat used within HRSG 142 to produce steam from at least one boiler feedwater source (not shown). HRSG 142 is also coupled in flow communication with at least one heat transfer apparatus 144 via at least one steam conduit 146. Apparatus 144 is also coupled in flow communication with at least one heated boiler feedwater conduit (not shown), such that apparatus 144 receives heated boiler feedwater (not shown) from the same or a separate boiler feedwater source (not shown). In the exemplary embodiment, apparatus 144 is a radiant syngas cooler (RSC). Alternatively, apparatus 144 may be any heat transfer apparatus that enables IGCC plant 100 to function as described herein. HRSG 142 receives steam (not shown) from apparatus 144 via conduit 146, wherein HRSG 142 increases the heat energy of the steam. HRSG 142 is coupled in flow communication with turbine 132 via a steam conduit 150. In the exemplary embodiment, cooled combustion gases are exhausted from HRSG 142 to the atmosphere via stack gas conduit 152. Alternatively, at least a portion of the excess combustion gases from HRSG 142 are channeled for use elsewhere in IGCC plant 100. Additionally, combustion gases may be cleaned, or scrubbed prior to being exhausted to the atmosphere.

Conduit 150 channels steam (not shown) from HRSG 142 to turbine 132. Turbine 132 receives the steam from HRSG 142 and converts the thermal energy in the steam to rotational energy. The rotational energy is transmitted to generator 134 via rotor 136, wherein generator 134 converts the rotational energy to electrical energy that is transmitted to at least one load, such as, but not limited to, the electrical power grid. The steam is condensed and returned as boiler feedwater via a condensate conduit (not shown). Alternatively, at least a portion of the steam from HRSG 142, steam turbine 132 and/or heat transfer apparatus 144 is channeled for use elsewhere in IGCC plant 100.

In the exemplary embodiment, IGCC plant 100 also includes a gasification system 200. More specifically, in the exemplary embodiment, system 200 includes at least one air separation unit 202 that is coupled in flow communication with an air source via an air conduit 204. The air sources include, but are not limited to only including, dedicated air compressors (not shown) and a compressor (not shown) typically associated with gas turbine engine 110. Unit 202 separates air into one or more streams of oxygen (O₂), nitrogen (N₂) and other component streams (neither shown). The other component streams may be released via a vent (not shown) to atmosphere or may be collected in a storage unit (not shown). In the exemplary embodiment, at least a portion of N₂ is channeled to gas turbine 114 via a N₂ conduit 206 to facilitate combustion.

System 200 includes a gasification reactor 208 that is coupled in flow communication with unit 202 to receive O₂ discharged from unit 202 via an O₂ conduit 210. In the exemplary embodiment, system 200 also includes a material grinding and slurrying unit 211. Unit 211 is coupled in flow communication with a carbonaceous material source and a water source (neither shown) via a carbonaceous material supply conduit 212 and a water supply conduit 213, respectively. In the exemplary embodiment, the carbonaceous material is coal, petroleum coke (or pet coke) or a mixture of coal and pet coke. Moreover, in the exemplary embodiment, unit 211 mixes the coal/pet coke and water to form a coal/pet coke slurry stream that is channeled to reactor 208 via a coal/pet coke slurry conduit 214. Alternatively, any material that includes carbonaceous solids may be used that facilitates operation of IGCC plant 100 as described herein. Also, alternatively, non-slurry fuels that include solid, liquid and gaseous fuel substances may be used, including mixtures of fuels and other materials, such as but not limited to, fuel and slag additives.

Reactor 208 receives the material slurry stream and an O₂ stream via conduits 214 and 210, respectively. Reactor 208 produces a hot, raw synthetic gas (syngas) stream. Moreover, reactor 208 produces hot slag and char as solid byproducts of the syngas production.

Reactor 208 is coupled in flow communication with heat transfer apparatus 144 via a hot syngas conduit 218. Apparatus 144 receives the hot, raw syngas stream and transfers at least a portion of the heat to HRSG 142 via conduit 146. Subsequently, apparatus 144 produces a cooled, raw syngas stream (not shown) that, in the exemplary embodiment, is channeled to a scrubber and to a low temperature gas cooling (LTGC) unit 221 via a syngas conduit 219. Unit 221 removes at least a portion of the slag and char entrained within the raw syngas stream (sometimes referred to as “fines”) via a fines conduit 222. The fines are channeled to a waste product collection, handling, and processing apparatus 223 via conduit 222. In the exemplary embodiment, the fines are subject to a carbon reactivation process and to take advantage of the unused carbon content within, the fines are then channeled to gasification reactor 208. More generally, in the exemplary embodiment, gasification system 200, and more specifically gasification reactor 208, is a solid waste generation system and a solid waste consumption system. Alternatively, a first portion of the fines is subjected to the carbon reactivation process prior to being channeled to gasification reactor 208, and a second portion of the fines is separated for ultimate disposal. Unit 221 also cools the raw syngas stream.

Apparatus 144 also removes at least a portion of the slag and char from the hot, raw syngas stream. Specifically, a slag and char handling unit 215 is coupled in flow communication with apparatus 144 via a hot slag conduit 216. Unit 215 quenches the balance of the char and slag, and simultaneously breaks the slag into smaller pieces, wherein a slag and char removal stream (not shown) produced is discharged through conduit 217. In a removal manner similar to that used with the fines as described above, the slag and char are channeled to waste product collection, handling, and processing apparatus 223 via conduit 217. In the exemplary embodiment, the slag and char are subjected to a carbon reactivation process and take advantage of unused carbon content within the slag and char that are channeled to gasification reactor 208. More generally, in the exemplary embodiment, gasification system 200, and more specifically gasification reactor 208, is a solid waste generation system and a solid waste consumption system. Alternatively, a first portion of the slag and char is subjected to the carbon reactivation process prior to being channeled to gasification reactor 208, and a second portion of the slag and char is separated for disposal from system 200.

System 200 also includes an acid gas removal subsystem 230 that is coupled in flow communication with unit 221 and that receives the cooled raw syngas stream via a raw syngas conduit 220. Subsystem 230 removes at least a portion of acid components (not shown) from the raw syngas stream as described in more detail below. Such acid gas components include, but are not limited to, H₂S and CO₂. Subsystem 230 also separates at least some of the acid gas components into components that include, but are not limited to, H₂S and CO₂. In the exemplary embodiment, CO₂ is not recycled and/or sequestered. Alternatively, subsystem 230 is coupled in flow communication with reactor 208 via at least one CO₂ conduit (not shown) wherein at least a portion of the stream of CO₂ (not shown) is channeled to predetermined portions of reactor 208. The removal of CO₂ and H₂S via subsystem 230 enables a clean syngas stream to be produced that is channeled to gas turbine 114 via a clean syngas conduit 228.

Gasification system 200 also includes a carbon reactivation system 300. In the exemplary embodiment, system 300 includes a solids recycle and carbon reactivation apparatus 302 that is coupled in flow communication with apparatus 223 via a solid waste byproducts conduit 304. Alternatively, apparatus 302 is coupled in flow communication with apparatus 223 via an optional waste product separation apparatus 306, a solid waste byproducts conduit 308, and separated carbonaceous solids conduit 310. Apparatus 306 is coupled in flow communication with a waste products disposal apparatus (not shown) via a separated waste solids conduit 312. In the exemplary embodiment, apparatus 302 is coupled in flow communication with material grinding and slurry unit 211 via a first reactivated solids conduit 314. Alternatively, apparatus 302 is coupled in flow communication with gasification reactor 208 via a second reactivated solids conduit 316.

In the exemplary embodiment, solids recycle and carbon reactivation apparatus 302 is an acid and/or base treatment-type apparatus that increases the reactivity of residual carbon in the solids through the use of strong acids and/or bases. Alternatively, apparatus 302 is a treatment-type apparatus that increases the reactivity of residual carbon in the solids through the use of black liquor formed from gasification process byproducts and/or leachates from biomass treatment processes. Also, alternatively, apparatus 302 is a treatment-type apparatus that increases the reactivity of residual carbon in the solids through the use of salts, such as metal salts including, but not limited to, alkali and alkaline earth metal salts. Further, alternatively, apparatus 302 is a treatment-type apparatus that increases the reactivity of residual carbon in the solids through the use of an admixture with promoters that include, but are not limited to, transition metal oxides and/or other organic or inorganic transition metal-containing compounds such as, but not, limited to, oxides, hydroxides, carbonates, and acetates. Moreover, alternatively, apparatus 302 is any apparatus that enables system 300 to function as described herein.

In a first alternative embodiment, optional separation apparatus 306 is a density separation-type apparatus that separates lower-density carbon-rich portions of the slag, char, and fines that are channeled from apparatus 223 using, for example, floating-type separation and/or centrifugal-type separation. In another alternative embodiment, optional separation apparatus 306 is a flocculation-type apparatus that facilitates agglomeration of carbon-rich portions of the slag, char, and fines that are channeled from apparatus 223. In a further alternative embodiment, optional separation apparatus 306 is a triboelectric-type separation apparatus that facilitates friction-induced electrostatic charging of carbon-rich portions of the slag, char, and fines that are channeled from apparatus 223. Also, in another alternative embodiment, optional separation apparatus 306 is a size separation-type apparatus that facilitates separating smaller carbon-rich portions of the slag, char, and fines that are channeled from apparatus 223. Further, alternatively, any separation apparatus and/or method that enable gasification system 200 to operate as described herein may be used, including, but not limited to, methods and apparatus that facilitate direct recovery of the carbonaceous energy content embedded within the slag, char, and fines.

In operation, air separation unit 202 receives air via conduit 204. The air is separated into O₂, N₂ and other components. The other components are vented or collected, wherein at least a portion of N₂ is channeled to turbine 114 via a conduit 206 and at least a portion of O₂ is channeled to gasification reactor 208 via conduit 210. Remaining portions of N₂ and O₂ may be channeled as a plurality of streams to other portions of IGCC plant 100. Also, in operation, material grinding and slurrying unit 211 receives coal, pet coke, or a coal and pet coke mixture and water via conduits 212 and 213, respectively, forms a coal/pet coke slurry stream and channels the coal/pet coke slurry stream to reactor 208 via conduit 214.

Reactor 208 receives the O₂ via conduit 210 and coal, pet coke, or coal/pet coke mixture via conduit 214. Reactor 208 produces a hot raw syngas stream that is channeled to apparatus 144 via conduit 218. Some of the slag byproduct formed in reactor 208 is removed via slag handling unit 215 and conduits 216 and 217. Apparatus 144 facilitates cooling the hot raw syngas stream to produce a cooled raw syngas stream that is channeled to scrubber and LTGC unit 221 via conduit 219 and the syngas is additionally cooled. Particulate matter, including some of the slag and char (in the form of fines), is removed from the syngas via conduit 222. The cool raw syngas stream is channeled to acid gas removal subsystem 230 wherein acid gas components are selectively removed such that a clean syngas stream is formed and channeled to gas turbine 114 via conduit 228.

Moreover, in operation, turbine 114 receives N₂ and clean syngas via conduits 206 and 228, respectively. Compressed air supplied to turbine 114 from at least one air source (not shown) is subsequently mixed and combusted with the syngas fuel to produce hot combustion gases. Turbine 114 channels the hot combustion gases to induce rotation of turbine 114 which subsequently rotates first generator 118 via rotor 120. At least a portion of the exhaust gases is channeled to HRSG 142 from turbine 114 via an exhaust gas conduit 148 to facilitate generating steam.

Furthermore, in operation, at least a portion of the heat removed from the hot syngas via heat transfer apparatus 144 is channeled to HRSG 142 as steam via conduit 146. HRSG 142 receives the steam from apparatus 144, together with one or more streams of boiler feed water, and the exhaust gases discharged from turbine 114. Heat is transferred from the exhaust gases to the streams of boiler feedwater and to the steam from apparatus 144, such that one or more subsequent streams of steam are produced and such that the heat energy contained in the steam from apparatus 144 is increased. In the exemplary embodiment, at least one of the streams of steam generated as described above is heated to superheated conditions. Alternatively, one or more of the streams of steam are mixed together to form streams that may be heated to superheated conditions. Alternatively, high temperature saturated steam is formed. At least a portion of the superheated steam is channeled to steam turbine 132 via conduit 150 and induces a rotation of turbine 132. Turbine 132 rotates second generator 134 via second rotor 136. Any remaining portion of the steam is channeled for use elsewhere within IGCC plant 100.

Also, in operation, within gasification reactor 208, at least some of the organic materials, that is, carbon-containing compounds included within the carbonaceous material injected into reactor 208, are released from the injected material, thereby forming syngas. In contrast, inorganic matter included within the injected material typically melts and forms a liquid slag (not shown) that flows down along a refractory wall (not shown) of reactor 208. During its residence time in reactor 208, char may embed within the molten slag. The molten slag is quenched in a quench tower (not shown) within unit 215, thereby forming waste, or black water, and the slag enters a lock hopper (not shown) within unit 215 for discharge. Slag discharged from the lock hopper in unit 215 is typically referred to as “coarse slag.” Also, in gasification reactor 208, some of the inorganic matter at a fine-size is entrained within the syngas and exits reactor 208 with the syngas. Syngas cleanup within a scrubber portion (not shown) of unit 221 facilitates the capture of such fine-sized inorganic matter, or fines within the waste, or black water, contained therein. Black water streams discharged from units 215 and 221 are mixed together and thus contribute to additional inorganic matter being mixed in with the fines.

Carbon content within individual fines and pieces of char and slag, hereonafter referred to as carbon-containing particles, is typically not homogeneous and an amount of residual solid carbon varies in such carbon-containing particles. For example, carbon may be concentrated in smaller particles, or in larger particles. Also, carbon morphology, i.e., structural characteristics of the residual carbon, can also vary as a function of particle morphology. For example, at least some carbonaceous particles may include mostly carbon, at least some inorganic particles may include carbon concentrated on an outer surface of the particles, and carbon-rich inclusions may reside inside solid inorganic particles. Typically, the fines include a considerable amount of carbon as compared to the course slag. Often, a reactivity of the carbon in the fines is lower than a reactivity of the carbon in the slag and char particles, and as such, it is more difficult to react the carbon in the fines than the carbon in the slag and char particles.

Regardless of the concentration and morphology of the residual carbon, a reactivity of the residual carbon is generally lower than a reactivity of carbon contained in a fresh fuel feed. The lower reactivity is caused by a number of factors, such as, but not limited to, the loss of active functional groups, during devolatilization and gasification, the fusion of carbon atoms into stable fused aromatic ring structures, the thermal annealing of active sites, and/or the loss of exposed carbon surface area.

Moreover, during operation, at least a portion of particles exiting gasification reactor 208 is channeled to carbon reactivation system 300 via conduits 217 and 222. Specifically, particles are channeled to apparatus 223, wherein the particles are either channeled to separation apparatus 306 or channeled to reactivation apparatus 302. Additional grinding can be performed within apparatus 223 to facilitate increasing an available surface area of the particles and to expose additional active sites on the particles. In the event that separation apparatus 306 is used, the particles are channeled to apparatus 306 via conduit 308 and separation is performed by at least one of size separation including, but not limited to, sieving and classification, density separation (floating or centrifugal), flocculation, and triboelectric separation. Separated organic solids, that is, carbonaceous solids, are channeled to reactivation apparatus via conduit 310 and separated inorganic solids, that is, waste solids, are channeled to the waste products disposal apparatus via conduit 312.

Moreover, in operation, the particles are channeled to apparatus 302 directly from apparatus 223, or alternatively, after separation from the substantially inorganic waste solids. The carbon-rich particles are channeled to apparatus 302 to be re-activated prior to re-injection into reactor 208. In the exemplary embodiment, reactivation apparatus 302 increases the reactivity of residual carbon in the carbon-rich particles through the use of strong acids and bases. Use of either acids or bases is dependent upon a chemistry of the particles. The strong acids and bases dissolve plugs formed over pores in the particles to expose residual carbon regions.

Alternatively, in operation, apparatus 302 uses black liquor formed from gasification process byproducts and/or leachates from biomass treatment processes. Also, alternatively, apparatus 302 increases the reactivity of residual carbon in the particles through the use additives such as metal salts including, but not limited to, alkali and alkaline earth metal salts. Further, alternatively, apparatus 302 increases the reactivity of residual carbon in the particles through the use of an admixture with promoters that include, but are not limited to, oxides of transition metals. As defined herein, such transition metals include elements having an atomic structure with an incomplete d sub-shell or elements that can give rise to cations with an incomplete d sub-shell. Such transition metals include, but are not limited to, titanium, vanadium, manganese, iron, nickel, and copper. Moreover, alternatively, apparatus 302 increases the reactivity of residual carbon in the particles through the use of an admixture with promoters that include, but are not limited to, organic or inorganic compounds containing transition metals such as, but not limited to, oxides, hydroxides, carbonates, and acetates. The promoters chemically associate with the residual carbon atoms and are activated within gasification reactor 208 to enable reactivation of the residual carbon therein. Moreover, alternatively, additional grinding can be performed within apparatus 302 to facilitate increasing available surface area and to expose more active sites. Also, alternatively, any of the aforementioned methods may be combined and/or implemented in any order within apparatus 302, for example, but not limited to, washing the particles with either an acid or a base, then adding an oxide-type promoter, wherein grinding can be performed before the first method, between the two methods, or after the second method.

Further, in operation, regardless of the method of reactivation, apparatus 302 forms a stream of reactivated solids (not shown), wherein reactivated solids are channeled from apparatus 302 to material grinding and slurry unit 211 via conduit 314. The reactivated solids are mixed with fresh carbonaceous material channeled to unit 211 via conduit 212. Alternatively, the stream of reactivated solids is channeled directly into gasification reactor 208 via conduit 316. The flow of reactivated solids through either or both of conduits 314 and 316, is predetermined to reduce a potential for deleterious effects of syngas generation within reactor 208 as a result of reactivated solids injection. Moreover, operator observation and action that includes modulation of fresh carbonaceous material flow, reactivated solids flow and oxygen flow further reduces such a potential for deleterious effects.

As described herein, in the exemplary embodiment, gasification system 200, and more specifically gasification reactor 208, is a solid waste generation system and a solid waste consumption system. Alternatively, any solid waste generation system that enables operation of carbon reactivation system 300 as described herein is used. Also, alternatively, any solid waste consumption system that enables operation of carbon reactivation system 300 as described herein is used including, but not limited to, auxiliary boilers and kilns.

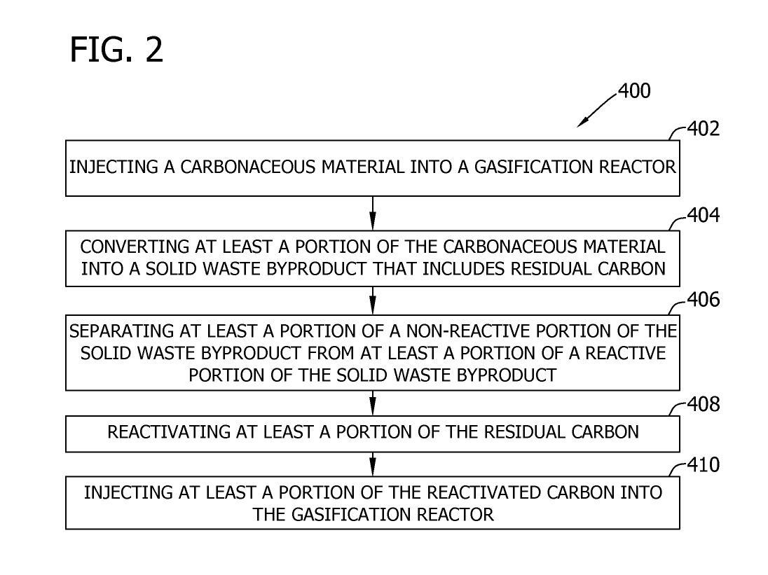

FIG. 2 is a flow chart illustrating an exemplary method 400 of operating IGCC power generation plant 100 (shown in FIG. 1). In the exemplary embodiment, a carbonaceous material is injected 402 into gasification reactor 208 (shown in FIG. 1) via material slurry conduit 214 (shown in FIG. 1). At least a portion of the carbonaceous material is converted 404 into a solid waste byproduct that includes residual carbon. At least a portion of a non-reactive portion of the solid waste byproduct is separated 406 from at least the portion of the reactive portion of the solid waste byproduct. At least a portion of the residual carbon is reactivated 408. At least a portion of the reactivated carbon is injected 410 into gasification reactor 208.

Described herein are exemplary embodiments of methods and apparatus that facilitate production of synthetic gas (syngas), specifically, reactivating carbon within syngas production waste byproducts and injecting the reactivated carbon into a gasification reactor. Such reactivation facilitates reducing an amount of waste material ultimately disposed of while increasing an overall ratio of syngas production per unit of injected fuel, both resulting in reduced operating costs. Moreover, separation of reactive organic solids from inorganic non-reactive solids prior to reactivation improves an efficiency of carbon reactivation since non-reactive materials are not subjected to the reactivation process. Such separation also facilitates an efficiency of gasification by reducing an energy penalty associated with heating of non-reactive materials. Moreover, an expected lifetime of reactivation system components is facilitated by reducing wear associated with handling and preparing non-reactive materials.

The methods and systems described herein are not limited to the specific embodiments described herein. For example, components of each system and/or steps of each method may be used and/or practiced independently and separately from other components and/or steps described herein. In addition, each component and/or step may also be used and/or practiced with other assembly packages and methods.

While the invention has been described in terms of various specific embodiments, those skilled in the art will recognize that the invention can be practiced with modification within the spirit and scope of the claims.

What is claimed is:

1. A method of operating a gasification facility, said method comprising:
injecting a carbonaceous material into a gasification reactor;
converting at least a portion of the carbonaceous material into a solid waste byproduct that includes residual carbon;
reactivating at least a portion of the residual carbon; and
injecting at least a portion of the reactivated carbon into the gasification reactor.

2. A method in accordance with claim 1, wherein reactivating at least a portion of the residual carbon comprises separating at least a portion of a non-reactive portion of the solid waste byproduct from at least a portion of a reactive portion of the solid waste byproduct.

3. A method in accordance with claim 2, wherein separating at least a portion of a non-reactive portion of the solid waste byproduct comprises at least one of:
size separation;
floating-type density separation;
centrifugal-type density separation;
flocculation; and
triboelectric separation.

4. A method in accordance with claim 2, wherein reactivating at least a portion of the residual carbon comprises at least one of:
mixing at least one of an acid and a base with at least a portion of the reactive portion of the solid waste byproduct;
mixing at least one of a gasification process liquid byproduct and leachates from biomass treatment with at least a portion of the reactive portion of the solid waste byproduct;
mixing at least one metal salt with at least a portion of the reactive portion of the solid waste byproduct; and
mixing an admixture with promoters with at least a portion of the reactive portion of the solid waste byproduct.

5. A method in accordance with claim 4, wherein using an admixture with promoters comprises using oxides of transition metals

6. A method in accordance with claim 4, wherein mixing an admixture with promoters comprises using at least one of organic and inorganic compounds including transition metals that include at least one of oxides, hydroxides, carbonates, and acetates.

7. A method in accordance with claim 2, wherein reactivating at least a portion of the residual carbon comprises grinding at least a portion of the reactive portion of the solid waste byproduct.

8. A method in accordance with claim 1, wherein injecting at least a portion of the reactivated carbon into the gasification reactor comprises mixing at least a portion of the reactivated carbon with the carbonaceous material.

9. A carbon reactivation system comprising:
at least one of a solid waste byproducts conduit coupled in flow communication with a solid waste generation system and a reactivated solids conduit coupled in flow communication with a solid waste consumption system; and
a carbon reactivation apparatus coupled in flow communication with at least one of said solid waste byproducts conduit and said reactivated solids conduit.

10. A carbon reactivation system in accordance with claim 9, wherein:
said solid waste byproducts conduit is coupled in flow communication with a first portion of the solid waste generation system; and
said reactivated solids conduit is coupled in flow communication with a second portion of the solid waste generation system.

11. A carbon reactivation system in accordance with claim 9, wherein said carbon reactivation apparatus is a reactivation apparatus that increases the reactivity of residual carbon in carbon-rich particles through the use of at least one of:
acids and bases;
black liquor formed from at least one of gasification process byproducts and leachates from biomass treatment processes;
at least one metal salt; and
an admixture with promoters.

12. A carbon reactivation system in accordance with claim 9 further comprising a solid waste byproducts separation apparatus coupled in flow communication with said at least one solid waste byproducts conduit and said carbon reactivation apparatus.

13. A carbon reactivation system in accordance with claim 12, wherein said solid waste byproducts separation apparatus comprises at least one of:
a size separation apparatus;
a floating-type separation apparatus;
a centrifugal-type separation apparatus;
a flocculation-type separation apparatus; and
a triboelectric-type separation apparatus.

14. A carbon reactivation system in accordance with claim 12, wherein at least one of said carbon reactivation apparatus and solid waste byproducts separation apparatus comprises at least one grinder.

15. A gasification system comprising:
a gasification reactor that produces solid waste byproducts;
a solid waste byproduct collection apparatus coupled in flow communication with said gasification reactor; and
a carbon reactivation system comprising:
at least one solid waste byproducts conduit coupled in flow communication with said solid waste byproduct collection apparatus; and
a carbon reactivation apparatus coupled in flow communication with said at least one solid waste byproducts conduit.

16. A gasification system in accordance with claim 15 further comprising at least one reactivated solids conduit coupled in flow communication with said carbon reactivation apparatus and at least one of said gasification reactor and a carbonaceous material supply unit.

17. A gasification system in accordance with claim 15, wherein said carbon reactivation apparatus is a reactivation apparatus that increases the reactivity of residual carbon in carbon-rich particles through the use of at least one of:
acids and bases;
black liquor formed from at least one of gasification process byproducts and leachates from biomass treatment processes;
at least one metal salt; and
an admixture with promoters.

18. A gasification system in accordance with claim 15 further comprising a solid waste byproducts separation apparatus coupled in flow communication with said at least one solid waste byproducts conduit and said carbon reactivation apparatus.

19. A carbon reactivation system in accordance with claim 18, wherein said solid waste byproducts separation apparatus comprises at least one of:
a size separation apparatus;
a floating-type separation apparatus;
a centrifugal-type separation apparatus;
a flocculation-type separation apparatus; and
a triboelectric-type separation apparatus.

20. A carbon reactivation system in accordance with claim 18, wherein at least one of said carbon reactivation apparatus and solid waste byproducts separation apparatus comprises at least one grinder.
